(19) United States
(12) Patent Application Publication
(10) Pub. No.: US 2011/0097467 A1
(43) Pub. Date: Apr. 28, 2011

(54) Device and Method for Pinching at Least Two Dough Parts

(75) Inventor: Johannes Josephus Antonius Van Blokland, Beusichem (NL)

(73) Assignee: RADEMAKER B.V., Culemborg (NL)

(21) Appl. No.: 12/911,257

(22) Filed: Oct. 25, 2010

(30) Foreign Application Priority Data
Oct. 27, 2009 (EP) 09174128.0

(51) Int. Cl. A23P 1/10; A21D 6/00

(52) U.S. Cl. 426/496; 425/112

(57) ABSTRACT

The present invention relates to a device comprising a conveyor for conveying the dough parts wherein the pair of drivable pinchers is arranged along the conveyor movable with at least a directional component towards each other and wherein the sensor is arranged upstream in the direction of conveyance with respect to the pair of pincers. The invention further relates to a method for pinching at least two dough parts, comprising conveying the dough parts to a pinching location, detecting the presence of the dough parts by sensing means upstream with respect to the pinching location in a conveying direction and operating pinchers upon detection of the dough parts.

The present invention relates to a device and method for pinching at least two dough parts.

Pinching (or squeezing or clamping together of) dough parts commonly takes place in processes where the dough parts should be adjacent or connected during at least a part of a preparation or baking process. In the process of baking croissants for example, the tips of the legs of a croissant are pinched in order to keep the croissant in its curved form, despite of a bias or tension in the dough that tends to straighten the dough product. During the baking, the tips of the legs may or may not separate or be separated again.

In the art, pinching is either performed manually, or—in an automated process—on a number of dough parts at a time, by pinchers that are operated automatically. The pinchers are triggered at the same time at an instance that is based on a “known” position of the dough parts on a conveyor that leads them across the pinchers. In order to obtain such a known position of the dough parts, an outlining unit, for example comprising a plurality of parallel endless belts, is required.

The U.S. Pat. No. 4,582,472 describes a device for pinching croissants. The international patent application WO 2008/133114 described a device for connecting the ends of a rod shaped dough piece.

Pinching according to the art has several disadvantages, slowness being one of them. In the case of the above described automated process wherein dough pieces with parts to be pinched are conveyed batch wise, the reason therefore is that the simultaneous operation of multiple pairs of pinchers requires outlined dough parts, and units for outlining dough parts form a bottleneck in a speed of the dough line.

It is a goal of the present invention to provide a method and device for pinching at least two dough parts lacking the above disadvantages.

The invention therefore proposes a device for pinching at least two dough parts, comprising a pair of drivable pinchers, movable with at least a directional component towards each other, a sensor for providing a control signal upon sensing a presence of the dough parts and a controller, for driving the pinchers based on the control signal.

Since the drivable pinchers are provided with a sensor, the need of synchronising the drive of the pinchers with a conveyor, such as an endless belt, on which the dough parts to be pinched are positioned at beforehand known positions is no longer necessary, for the device detects the presence of the dough parts, and then pinches them. Evidently, the pinchers are oriented in such way that the through put of dough parts to be pinched takes place between them. Driving the pinchers can take place by means of an electrical drive with a controller, for example a servo system, that acts upon input from the sensor. Said sensor can be embodied by means of a mechanical sensor, or an optical sensor, arranged in a bridge or on a port, or any known sensor for detecting objects.

The device may further comprise a conveyor for conveying the dough parts; wherein the pair of drivable pinchers is arranged along the conveyor, and movable with at least a directional component towards each other, and wherein the sensor is arranged upstream in the direction of conveyance with respect to the pair of pinchers. Thereby the presence of dough parts can be detected at a predetermined distance before they reach the pinchers. In the case of multiple sets of pinchers, a further advantage is reached by providing each pair of pinchers with its own sensor, and thus eliminating the need to synchronise the dough parts, and also the need for a common control system for the plurality of sets of pinchers.

In an embodiment, the pinchers are rotatably arranged at a mutual distance. Both pinchers are configured to rotate in opposite directions, causing a directional component of at least the Working surfaces of the pinchers towards each other, and as a result also to the dough parts. Moreover, this way also a tangential movement with respect to the dough parts is obtained, eliminating the need for the pinching device as a whole to move along with the conveyor and/or the dough parts to be pinched. With respect to the state of the art, a major reduction of complexity and an increased operation speed can thus be obtained.

In order to avoid damaging the dough parts by the pinchers, at least one, and preferably both pinchers comprise an essentially flat working surface, with at least one knotted edge. This may be the leading edge in particular, but preferably sharp protrusions of any kind are omitted. In general, the shape of the contact surfaces of the pinchers may be designed according to a specific application or type of dough to be used, and may be textured for that purpose, or provided with a surface layer of a specific material, such as stainless steel. The pinchers may be made from or provided with HMPE (High Modulus Poly Ethylene) or stainless steel.

In an automated process, where a plurality of dough parts is conveyed at a time, or where dough parts are conveyed batch wise, a device may be preferred comprising a plurality of pairs of drivable pinchers, arranged at mutual distances in a direction perpendicular to a direction of conveyance of the dough parts.

The dough parts are generally arranged in parallel rows on the conveyor, for example five rows. In the case of croissants, and especially bended croissants, the croissants may not be perfectly outlined on the conveyor, as a result of preceding process steps, such as rolling and curving the croissants. For this purpose, the present invention is especially advantageous, since the various pairs of drivable pinchers do not need to be controlled synchronously, as they all have their own sensors. That means that a conveyor can be operated at a continuous speed, without interruptions. Especially in combination with rotating pinchers as described above, increased throughput speeds can be obtained with respect to the prior art.

In order to be adjustable to a variable number of rows of dough parts, the plurality of pairs of drivable pinchers can be arranged displaceable in the direction perpendicular to a direction of conveyance of the dough parts. Herewith, the distance between the pinchers can be altered, as to match the distance between the pairs of dough pieces to be pinched. It is also possible to change the number of pairs of pinchers that are at practice at the same time. For that purpose, at least one pair of pinchers can be displaceable to a parking position, outside a path of conveyance of the dough parts. With this feature it is possible to adapt the device to the number of pairs of dough parts to be pinched in a batch.

The pairs of pinchers can be embodied as a unit together with drive means, the sensor and control means, and as such be arranged movable along a track. Such track can be a bar or a rail system, and it is preferably provided with indication means such as a ruler, and/or predetermined default positions for the unit, in order to facilitate an operator or a mechanic to quickly change the settings of the device.

In another embodiment all sets of pinchers are displaceable out of the path of conveyance of the dough parts together. For that purpose, the bar or rail system carrying the unit may be provided with a lever, or be arranged on a frame that can be lifted or moved aside. With this feature, it is possible to determine dynamically whether or not to pinch the dough parts conveyed.

A further improvement with respect to the state of the art can be obtained when the sensor is configured to determine an extreme (such as a rear or a front flank) of the dough parts to be pinched. In case of a bent croissant, wherein the tips of the legs need to be pinched, it is possible that the legs are oriented at the leading side, or at the lagging side. In both cases, the moment of pinching can be adjusted in order to influence the amount of overlap between the pinchers and the dough parts, and thus to influence the length over which the dough parts are pinched. This length, and other parameters can be adjusted by an operator, for example via a user interface. Being able to determine the exact position and length of the pinching is even more desired when pinching filled dough products, such as croissants with jam, because a wrong position could easily lead to a leaking filling of the product, possibly resulting furthermore in pollution of the device.

The invention will now be elucidated into more detail with reference to the following figures, wherein:

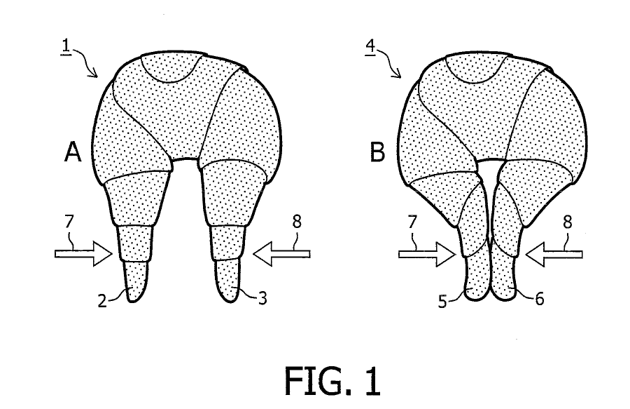

FIG. 1 shows a dough piece with parts to be pinched, and thus pinched dough parts;

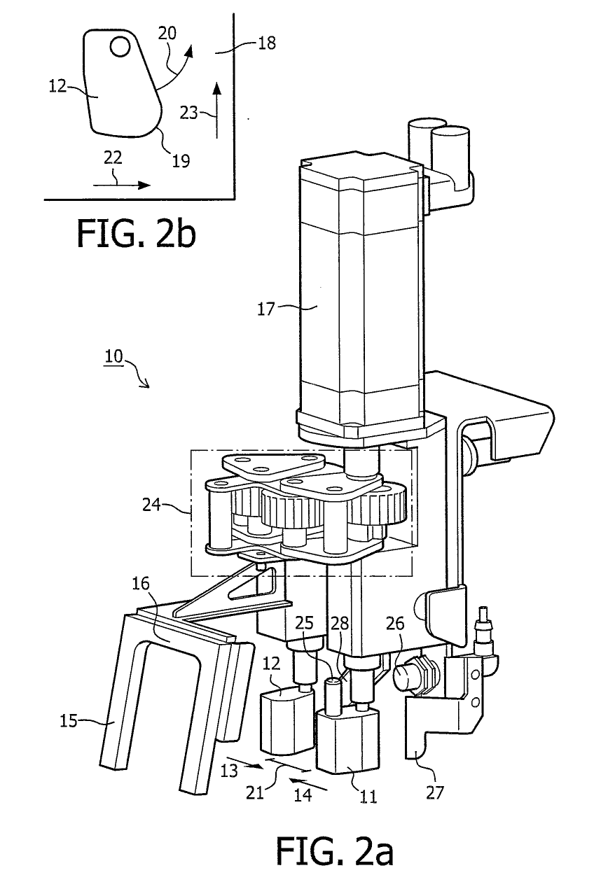

FIG. 2a shows a device according to the present invention;

FIG. 2b shows a detail from the device of FIG. 2a;

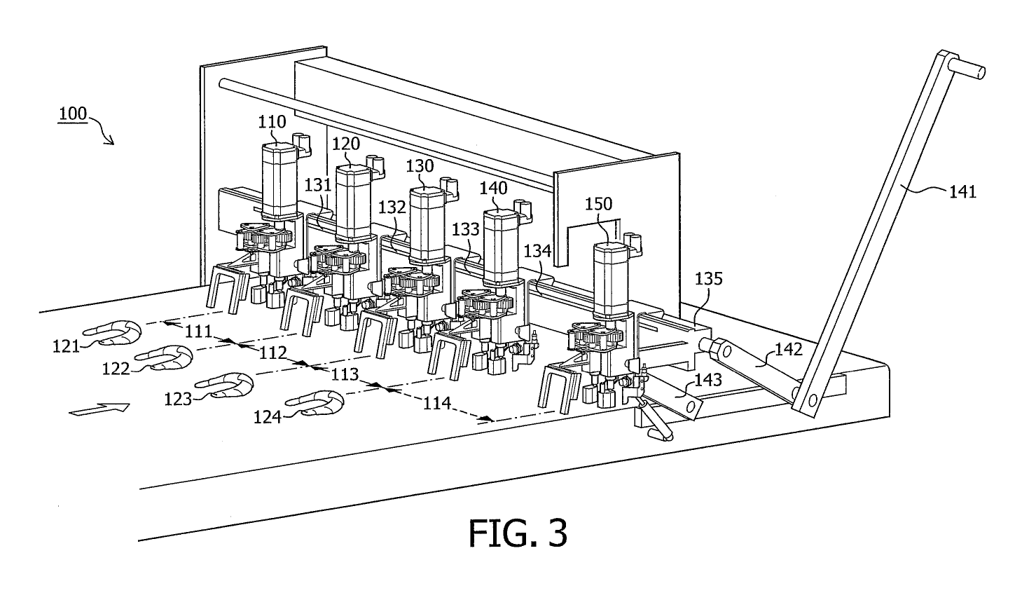

FIG. 3 shows a configuration with a plurality of devices from FIG. 2a;

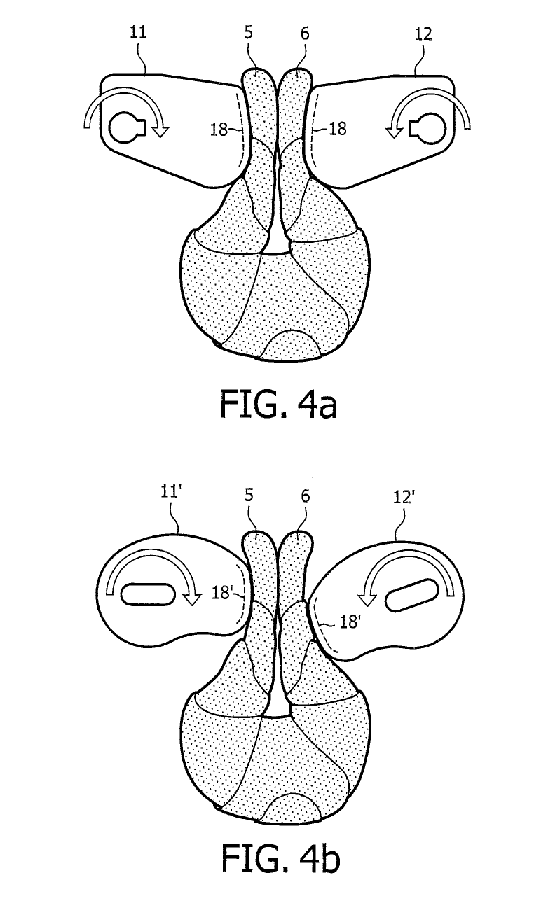

FIG. 4 shows 2 alternative designs of the pinchers.

FIG. 1 shows a first dough piece 1, in the case shown a croissant, with two dough parts 2 and 3, formed by the legs of the croissant, that should be pinched in order to keep the croissant in its round shape during at least part of the preparing and/or baking process. For example during transfer of the croissant from a first conveyor to a subsequent second conveyor, during proving, freezing or during the baking itself, wherein forces occurring when the dough rises should be counteracted. Thereto, legs 2 and 3 should be pinched in the direction of the arrows 7 and 8. A croissant 4 is thus obtained, wherein dough parts or legs 5 and 6 are stuck together.

FIG. 2a shows a device 10 for pinching at least two dough parts according to the present invention, comprising a pair of drivable pinchers 11, 12 movable with at least a directional component 13, 14 towards each other, a sensor 15, embodied by a port 16 provided with detection means, for providing a control signal upon sensing a presence of dough parts and a controller, in the embodiment shown embodied by a servo system, for driving the pinchers based on the control signal from the sensor 15. Both pinchers 11, 12 are rotatably 20 arranged at a mutual distance 21, and they comprise an essentially flat working surface 18, with at least one knotted edge 19, as depicted in the detailed top view of FIG. 2b. The knotted edge is the leading edge with a directional component 22 toward the dough part to be pinched, and by knotting or rounding its edge, damaging the dough is avoided when rotating 20 the pincher 12. Evidently the same goes for (non-depicted) pincher 11. Upon rotation 20, the working surface 18 obtains a speed component in the transversal direction 23, which is the direction of conveyance of the dough parts to be pinched and/or the converted dough products. By programming the controllable motor 17 the rotational speed of the pinchers 12, 18 can be adjusted. Depending on the type of dough used, the speed in transversal direction can be lower, but is preferred to be equal or even somewhat higher than the speed of conveyance of the dough parts, in order to avoid ripping the dough. The rotational speed of the pinchers 11, 12 may be constant during a pinching operation, but it may also be controlled by the controller and/or the servo that drives them to compensate for the sinoidal curve the transversal component 23 of the speed of the working surface 18. The distance 21 between the pinchers 11, 12 is adjustable, and planetary gearwheels 24 are provided to keep the mutual orientation between the pinchers 11, 12 during such adjustments. Detection means 25, 26 for the angular orientation of the pinchers are present, and may be used to return the pinchers to a default position after and/or before pinching. Furthermore, scrapers 27 and 28 are shown, for cleaning respective pinchers 11, 12. The scrapers are especially advantageous in the shown case where rotational pinchers 11, 12 are used, since in these configurations, the dough and the pinchers may have transversal speed differences during at least part of the mutual contact.

FIG. 3 shows a device 100 according to the present invention for simultaneously pinching a plurality of pairs of dough parts, comprising five pairs 110, 120, 130, 140, 150 of drivable pinchers, arranged at mutual distances 111, 112, 113, 114 in a direction perpendicular to a direction of conveyance of the dough parts. The mutual differences correspond to the distances between dough products 121, 122, 123 and 124. In order to enable use with different distances or different amounts of dough products per batch, the pairs 110, 120, 130, 140, 150 of drivable pinchers are arranged displaceable in the direction perpendicular to a direction of conveyance of the dough parts. For that reason, slotted holes 131, 132, 133, 134 are provided in carrying bar 135. The bar 135 may be provided with a ruler or other indications for the exact location and/or mutual distance between the pairs 110, 120, 130, 140, 150 of drivable pinchers. In FIG. 3, one pair of pinchers 150 has been moved to a parking position, outside a path of conveyance of the dough parts. A like parking position can—in the case shown—be used to enable switching between 4 and 5 dough products to be pinched at a time. Evidently, configurations wherein one can switch between other numbers can be imagined as well. The device further comprises a lever 141 with lever arms 142 and 143, which can be used to lift the bar 135 with the pairs 110, 120, 130, 140, 150 of drivable pinchers all at once. This lever may be used in order to switch directly from pinched to non-pinched production modes of dough products. In order to be able to control the length of the pinched part, the amount of time between detection of the dough parts or the distance of translation of the conveyor and triggering the pinchers may be varied. The active surface of the pinchers may be oversized for the actual purpose, so that any desired length of pinch can be obtained.

FIG. 4a shows the pinchers 11 and 12 from the devices 10 and 100 in more detail. Dough parts 5 and 6 are clamped in between the working surfaces of the pinchers 11 and 12.

FIG. 4b shows an alternative embodiment with pinchers 11′ and 12′, having more rounded working surfaces 18′, adapted for pinching more fragile types of dough parts.

1. Device for pinching at least two dough parts, such as two legs of a croissant, comprising:
a pair of drivable pinchers movable with at least a directional component towards each other,
a sensor for providing a control signal upon sensing a presence of the dough parts;
a controller, for driving the pinchers based on the control signal, Characterised in that
the length of the overlap of the pinchers and the dough parts is adjustable.

2. Device according to claim 1, comprising:
a conveyor for conveying the dough parts; wherein
the pair of drivable pinchers is arranged along the conveyor movable with at least a directional component towards each other; and wherein
the sensor is arranged upstream in the direction of conveyance with respect to the pair of pincers.

3. Device according to claim 1 or 2, wherein the pinchers are rotatably arranged at a mutual distance.

4. Device according to claim 3, wherein at least one of the pinchers comprises an essentially flat working surface, with at least one knotted edge.

5. Device according to any of the preceding claims, comprising a plurality of pairs of drivable pinchers, arranged at mutual distances in a direction perpendicular to a direction of conveyance of the dough parts.

6. Device according to claim 5, wherein the plurality of pairs of drivable pinchers are arranged displaceable in the direction perpendicular to a direction of conveyance of the dough parts.

7. Device according to claim 6, wherein at least one pair of pinchers can be displaceable to a parking position, outside a path of conveyance of the dough parts.

8. Device according to any of the preceding claims, wherein all sets of pinchers are displaceable out of the path of conveyance of the dough parts together.

9. Device according to any of the preceding claims, wherein the sensor is configured to detect a front or rear flank of a dough part.

10. Device according to any of the preceding claims, wherein the rotational speed of the pinchers is controlled by a controller and/or servo that drives them to compensate for the sinoidal curve the transversal component of the speed of the working surface 1 of the pinchers.

11. Method for pinching at least two dough parts, comprising:
conveying the dough parts to a pinching location;
detecting the presence of the dough parts by sensing means upstream with respect to the pinching location in a conveying direction;
operating pinchers upon detection of the dough parts.

12. Method of pinching dough parts according to claim 11, comprising:
pinching the dough parts by rotating the pinchers when the dough parts at a moment where the dough parts are in between the pinchers.

13. Method according to claim 12, wherein the conveyance of the dough parts is uninterrupted during pinching.

14. Method according to any of the claim 12 or 13, comprising:
controlling the length of the pinched part by varying the amount of time or a distance between detection of the dough parts and triggering the pinchers.

15. Method according to any of the claims 12-14, wherein
a speed of the pinchers is controlled in dependence of a speed of conveying the dough parts.
